(19) United States
(12) Patent Application Publication
(10) Pub. No.: US 2004/0229762 A1
(43) Pub. Date: Nov. 18, 2004

(54) Polymer remover

(75) Inventor: Edward W. Rutter JR., Pleasanton, CA (US)

Correspondence Address: S. Matthew Cairns, c/o EDWARDS & ANGELL, LLP, P.O. Box 9169, Boston, MA, 02209, US

(73) Assignee: Rohm and Haas Electronic Materials, L.L.C., Marlborough, MA

(21) Appl. No.: 10/845,878

(22) Filed: May 13, 2004

Related U.S. Application Data
(60) Provisional application No. 60/470,004, filed on May 13, 2003.

(51) Int. Cl. C11D 1/00

(52) U.S. Cl. 510/175

(57) ABSTRACT

Compositions useful for the removal of polymeric material from substrates, such as magnetoresistive sensors, are provided. Methods of removing such polymeric material from magnetoresistive sensors and methods of manufacturing magnetoresistive sensors are also provided.

### BACKGROUND OF THE INVENTION

The present invention relates generally to the field of removal of polymeric materials from a substrate. In particular, the present invention relates to compositions and methods for the removal of polymeric material from electronic devices.

Numerous materials containing polymers are used in the manufacture of electronic devices, such as circuits, disk drives, storage media devices and the like. Such polymeric materials are found in photoresists, solder masks, antireflective coatings, and the like. During manufacture of such electronic devices, the polymeric material is subjected to conditions that make the removal of such polymeric material difficult.

For example, most modern technology utilizes positive-type resist materials for lithographically delineating patterns onto a substrate so that the patterns can be subsequently etched or otherwise defined into the substrate material, although negative-type resists may also be used. The resist material is deposited as a film and the desired pattern is defined by exposing the resist film to energetic radiation. Thereafter the exposed regions are subject to a dissolution by a suitable developer liquid. After the pattern has been thus defined in the substrate the resist material must be completely removed from the substrate to avoid adversely affecting or hindering subsequent operations or processing steps.

It is necessary in such a photolithographic process that the photoresist material, following pattern delineation, be evenly and completely removed from all unexposed areas so as to permit further lithographic operations. Even the partial remains of a resist in an area to be further patterned is undesirable. Also, undesired resist residues between patterned lines can have deleterious effects on subsequent processes, such as metallization, or cause undesirable surface states and charges.

In fabrication of magnetic thin film heads for disk drive and data storage media devices, photoresists are commonly applied on a variety of thin films or layers as masking agents for precision design of magnetoresistive (“MR”), including giant magnetoresistive (“GMR”), sensors. Magnetic multilayered materials showing a different and more pronounced magnetoresistance as compared to conventional MR materials have been termed “giant magnetoresistive” materials. The photolithography and reactive ion etches used in the manufacture of MR materials resemble semiconductor processes. MR materials are typically built on various substrates such as aluminum titanium carbide ceramic wafers. GMR materials contain at least two ferromagnetic metal layers separated by a nonferromagnetic metal layer. Common thin metal layers associated with magnetoresistive heads include one or more of gold (“Au”), cobalt (“Co”), copper (“Cu”), iron (“Fe”), iridium (“Ir”), manganese (“Mn”), molybdenum (“Mo”), nickel (“Ni”), platinum (“Pt”), ruthenium (“Ru”), chromium (“Cr”), and zirconium (“Zr”). These films are completely different from those found in integrated circuit semiconductor fabrication which include predominantly aluminum (“Al”), tungsten (“W”), titanium (“Ti”), and silicon oxides as the interlayer dielectrics.

Within the last five years the technology for storage media has grown exponentially and has driven MR sensor performance through miniaturization and higher area density which today exceeds 20 Gb/in². In order to keep at pace with next generation technology, read-write head manufacturers are utilizing advanced photoresists and multi component ion etch recipes to achieve the desired thin layer stack patterns. Furthermore, to successfully integrate multiple layer stacks into sub-micron features with the correct magnetic and signal sensitivity, each layer within the device must be clean from polymer, ionic and other forms of organic/inorganic contamination or residue. Such undesired residue will adversely affect the device performance and reliability.

Traditional chemistry used in cleaning processes of thin film heads, including photoresist strip and metal lift-off, do not offer acceptable performance for modern MR sensor technology. Conventional photoresist removal or stripping formulations typically contain strong alkaline solutions, organic polar solvents or strong acids and oxidizing agents. Typical organic polar solvents include pyrrolidones such N-methyl pyrrolidone, N-ethyl pyrrolidone, N-hydroxyethyl pyrrolidone and N-cyclohexyl pyrrolidone; amides including dimethylacetamide or dimethylformamide; dimethylsulfoxide (“DMSO”); phenols and derivatives thereof. Such solvents may be used in combination with amines or other alkaline material.

Conventional stripping formulations are not effective in MR/GMR sensor or spin valve head manufacture due to the corrosive nature of such formulations toward the metals used in such sensors or spin valves. Thin film heads are unlike semiconductor devices and are ultra sensitive to galvanic and water induced mouse-bite corrosion, as well as, electrostatic discharge. For these reasons, modern thin film head back-end processes are now DI water-free and utilize isopropanol for rinse and dry steps of the cleaning sequence. This helps to minimize pole tip recession and corrosion at the thin film head level.

In addition, conventional stripping compositions have numerous other drawbacks including, undesirable flammability, toxicity, volatility, odor, necessity for use at elevated temperatures such as up to 100° C., and high cost due to the handling of regulated materials.

Attempts have been made to develop non-corrosive stripping formulations. For example, U.S. Pat. No. 6,531,436 (Sahbari et al.) discloses polymer stripping formulations including one or more polar aprotic solvents, one or more polymer dissolution enhancing bases such as tetramethyl ammonium hydroxide (“TMAH”), and one or more corrosion inhibitors. However, such formulations require an appropriate balance of corrosion inhibitor with polymer dissolution enhancing base in order to keep corrosion of the thin metal layers at a minimum.

There is a continuing need for strippers that effectively remove polymeric material and do not cause corrosion of the substrate, particularly thin metal films used in the manufacture of MR sensors.

### SUMMARY OF THE INVENTION

It has been surprisingly found that polymeric material may be easily and cleanly removed from substrates, particularly thin film heads for disk drive and storage media devices. Such polymeric material may be removed according to the present invention with greatly reduced or eliminated corrosion of underlying metal layers. Yield losses due to corrosion or erosion are also improved by using the stripping compositions of the present invention.

The present invention provides a composition suitable for the removal of polymeric material from a magnetoresistive substrate including cyclopentanone and one or more organic solvents selected from polyhydric alcohols or glycol ethers. The magnetoresistive substrate is any substrate used to manufacture magnetoresistive materials and typically contains at least one thin metal layer. More typically, the magnetoresistive substrate contains two or more thin metal layers.

Also provided by the present invention is a method of removing polymeric material from a magnetoresistive substrate including the step of contacting the substrate containing polymeric material to be removed with a composition including one or more cyclic ketones.

Further, the present invention provides a method for preparing magentoresistive sensors including the steps of disposing one or more polymeric materials on a magnetoresistive sensor substrate; and contacting the polymeric material on the magnetoresistive sensor substrate with a composition including one or more cyclic ketones for a period of time sufficient to remove the polymeric material.

### DETAILED DESCRIPTION OF THE INVENTION

As used throughout this specification, the following abbreviations shall have the following meanings unless the context clearly indicates otherwise: wt %=percent by weight; mL=milliliter; L=liter; ° C.=degrees Centigrade; Å=angstrom; and min.=minute. All amounts are percentages by weight. All numerical ranges are inclusive and combinable in any order except where it is clear that such numerical ranges are constrained to add up to 100%.

The terms “stripping” and “removing” are used interchangeably throughout this specification. Likewise, the terms “stripper” and “remover” are used interchangeably. “Alkyl” refers to linear, branched and cyclic alkyl.

Polymeric material may be easily and cleanly removed from magnetoresistive substrates, particularly sensors used in the manufacture of thin film heads for disk drive and storage media devices, by the step of contacting the substrate containing polymeric material to be removed with a composition including one or more cyclic ketones. Such polymeric material may be removed with greatly reduced or eliminated corrosion of metal layers.

A wide variety of polymer remover compositions may be employed in the present invention as long as such composition contains one or more cyclic ketones. Suitable cyclic ketones include, without limitation cyclo(C₅-C₈)alkanones. Exemplary cyclic ketones include, without limitation, cyclopentanone and cyclohexanone. Cyclic ketones are generally commercially available, such as from Aldrich (Milwaukee, Wis.), and may be used as is or may be further purified.

Optionally, the polymer remover compositions may contain one or more organic solvents. Such organic solvents are different from the cyclic ketones. A wide variety of organic solvents may be used in the present invention, provided that they are miscible with the one or more cyclic ketones. Suitable solvents include, without limitation: polyhydric alcohols; glycol ethers; alcohols such as (C₁-C₁₂)alkyl alcohols; esters such as ethyl acetate, butyl acetate and ethyl lactate; non-cyclic ketones such acetone, butanone and heptanone; alkanolamines such as ethanolamine, diethanolamine and iso-propanolamine; N-alkyl pyrrolidones; and combinations thereof. Such organic solvents are generally commercially available, such as from Aldrich, and may be used as is or may be further purified.

“Polyhydric alcohol” refers to any alcohol having two or more hydroxyl groups, such as (C₂-C₂₀)alkanediols, (C₂-C₂₀)alkanetriols, substituted (C₂-C₂₀)alkanediols, substituted (C₂-C₂₀)alkanetriols, as well as the corresponding tetraols and pentaols. Suitable polyhydric alcohols include, but are not limited to, ethylene glycol, diethylene glycol, triethylene glycol, polyethylene glycol, propylene glycol, dipropylene glycol, tripropylene glycol, polypropylene glycol, 1,3-propanediol, 2-methyl-1,3-propanediol, butanediol, pentanediol, hexanediol, and glycerol. Such polyhydric alcohols are generally commercially available, such as from Aldrich and Dow Chemical Company (Midland, Mich.), and may be used as is or may be further purified.

As used herein, the term “glycol ether” refers to any ether of a polyhydric alcohol. Exemplary glycol ethers include (C₁-C₆)alkyl ethers of (C₂-C₂₀)alkanediols or di(C₁-C₆)alkyl ethers of (C₂-C₂₀)alkanediols such as ethylene glycol, diethylene glycol, triethylene glycol, propylene glycol, 2-methylpropanediol, dipropylene glycol and tripropylene glycol. Exemplary glycol ethers include, without limitation, (C₁-C₂₀)alkanediol (C₁-C₆)alkyl ethers such as ethylene glycol monomethyl ether, diethylene glycol monomethyl ether, diethylene glycol monobutylether, diethylene glycol dimethyl ether, propylene glycol monomethyl ether, propylene glycol dimethyl ether, propylene glycol n-butyl ether, dipropylene glycol monomethyl ether (“DPM”), dipropylene glycol dimethyl ether, dipropyleneglycol monobutyl ether, tripropyleneglycol monomethyl ether and propylene glycol methyl ether acetate. Suitable glycol ethers are those sold under the DOWANOL tradename such as DOWANOL DPM, DOWANOL TPM, DOWANOL PNB, DOWANOL DB and DOWANOL DPNB (available from Dow Chemical Company), and may be used as is or may be further purified.

The present polymer remover compositions contain from 1 to 100 wt % cyclic ketones, based on the total weight of the composition. Exemplary compositions contain the one or more cyclic ketones in the range of from 5 to 90 wt %, from 10 to 80 wt %, from 10 to 70 wt %, or from 10 to 50 wt %, based on the total weight of the composition. The total organic solvents may be present in an amount of from 0 to 99 wt %. Exemplary compositions include from 10 to 95 wt % of organic solvents. Other suitable amounts of organic solvents include from 20 to 90 wt %, from 30 to 90 wt %, or from 50 to 90 wt %. Particularly suitable polymer remover compositions suitable for the removal of polymeric material from a magnetoresistive substrate include cyclopentanone and one or more organic solvents selected from polyhydric alcohols or (C₁-C₂₀)alkanediol (C₁-C₆)alkyl ethers.

An advantage of amine-free organic solvents, such as polyhydric alcohols, glycol ethers, alcohols, esters and non-cyclic ketones, is that corrosion inhibitors are not required, although they may be used. When amine containing solvents such as alkanolamines or N-alkyl pyrrolidones are used in the present compositions, a corrosion inhibitor is typically added, but is not necessarily required. Any corrosion inhibitor which reduces the corrosion of thin metal film layers may be used. Suitable corrosion inhibitors useful in the present invention include, but are not limited to, hydroxy-substituted aromatic compounds, and azoles such as imidazoles and triazoles. Other suitable corrosion inhibitors will be apparent to those skilled in the art. Exemplary corrosion inhibitors include, without limitation, catechol, (C₁-C₆)alkylcatechol such as methylcatechol, ethylcatechol and tert-butylcatechol, benzotriazole, (C₁-C₁₀)alkylbenzotriazoles; (C₁-C₁₀)hydroxyalkylbenzotriazoles; 2-mercaptobenimidazole, gallic acid; and gallic acid esters such as methyl gallate and propyl gallate. Such corrosion inhibitors are generally commercially available from a variety of sources, such as Aldrich (Milwaukee, Wis.) and may be used as is or may be further purified.

The corrosion inhibitors, when used, are typically present in the remover compositions in an amount in the range of from 0.01 to 10% wt, based on the total weight of the composition. Exemplary amounts of corrosion inhibitor are from 0.2 to 5% wt, from 0.5 to 3% wt, and from 1.5 to 2.5% wt.

The present polymer remover compositions may optionally include one or more of each of surfactants, chelating agents and anti-freeze agents. Any suitable surfactant may be used in the present compositions. Exemplary nonionic surfactants include alkyleneoxide polymers and copolymers, such as, but not limited to, polyethylene glycol, polypropylene glycol, ethyleneoxide (“EO”)/propyleneoxide (“PO”) copolymers, and capped alkyleneoxide polymers. The term “capped alkyleneoxide polymers” refers to alkyleneoxide polymers having one or more terminal alkoxy or aryloxy groups instead of a hydroxyl group. The EO/PO copolymers may be random copolymers or block copolymers. The molecular weights of the surfactants may vary over a wide range, such as from 250 to 500,000 Daltons. Suitable surfactants are generally commercially available from a variety of sources, such as BASF (Ludwigshafen, Germany). Exemplary compositions contain such surfactants in an amount of from 10 to 50,000 ppm. Other exemplary compositions contain from 50 to 25,000 ppm of surfactant, and still other exemplary compositions contain from 75 to 10,000 ppm of surfactant.

The polymer remover compositions may be prepared by combining the one or more cyclic ketones and any optional additives, such as organic solvents, corrosion inhibitors, surfactants, chelating agents and anti-freeze agents, in any order. Such compositions are typically free of added water.

An advantage of the present polymer remover compositions is that they are substantially non-corrosive to substrates containing metals, particularly thin layers of metals. By “thin layer of metal” it is meant a metal layer having a thickness of <10,000 Å, such as from 2 to 1000 Å. In particular, the present polymer remover compositions show reduced corrosivity to metal layers containing one or more of the following metals or alloys of any of these: Au, Ag, Co, Cu, Fe, Ir, Mn, Mo, Ni, Pt, Ru, Cr, and Zr, as compared to conventional polymer removers, particularly conventional amine-containing polymer removers.

A further advantage of the process of the present invention is that lower temperatures may be used than those used with known stripping compositions. Typically, the polymeric residue removal process may be carried out at any temperature, such as from room temperature to 120° C. The specific temperature used will depend upon the type of polymeric material to be removed and on the particular remover composition employed. It will be appreciated by those skilled in the art that the polymer remover compositions of the present invention may be heated by a variety of means.

The compositions of the present invention are suitable for removing one or more polymeric materials from a substrate. Suitable polymeric materials that can be removed by the present invention is any residue from photoresists, soldermasks, antireflective coatings, and combinations thereof. A variety of photoresists may be used in the manufacture of MR sensors, including deep-UV (248 nm and 193 nm) and I-line resists. Such resists may contain one or more of novolak resins, polyhydroxystyrene resins, or other suitable resin. The particular photoresists used are well within the ability of those skilled in the art. A wide variety of organic polymeric antireflective coatings may also be used in the manufacture of MR materials. Such antireflective coatings are typically selected to cooperate with the particular photoresist used. The selection of antireflective coatings is well within the ability of one skilled in the art. In one embodiment, the antireflective coating contains one or more chromophores such as an anthracenyl moiety.

In the manufacture of MR materials, such as MR sensors, the photoresist, in addition to functioning to define a pattern, may also function as a plating resist during additive metallization. When used as plating resists, the photoresists typically have a thickness in the range of the thickness of the metal layer to be deposited. Such plating resist layers can be up to several microns thick. In one embodiment, a photoresist is disposed on a MR sensor substrate, i.e. a substrate used in the manufacture of a MR sensor. Optionally, an antireflective coating may be disposed on the photoresist or between the photoresist and the MR sensor substrate. The photoresist is imaged and developed to define the pattern. Metal is then deposited in the pattern by contacting the patterned MR sensor substrate with a metal plating bath. Such plating baths may be either electrolytic or electroless. A wide variety of plating baths may be used, such as those used to deposit one or more of copper, nickel, gold, silver, tin, palladium, as well as alloy plating baths such as, without limitation, copper-tin, copper-bismuth, and copper-silver. Other suitable alloys include permalloy. By way of example, a copper electroplating bath typically contains a source of copper ions such as copper sulfate, an acid electrolyte such as sulfuric acid, and one or more organic additives such as brighteners, suppressors and levelers. Such acid copper plating bath typically has a pH of <1 to 4 and more typically <1 to 2. Other suitable plating baths are within the ability of those skilled in the art.

Upon contact with metal plating baths, particularly acidic plating baths, the organic polymeric material becomes more difficult to remove for conventional removers. The present polymer remover compositions containing one or more cyclic ketones readily remove such polymeric material.

Accordingly, polymeric residue on a substrate may be removed by contacting the substrate with a composition containing one or more cyclic ketones. The substrate may be contacted with the present remover compositions by any known means, such as by placing the substrate in a vessel containing the remover composition or by spraying such composition on the substrate. When the substrate is placed in a vessel, the level of the remover composition in the vessel is typically sufficient to completely immerse the polymer residue on the substrate. In an embodiment, the bath is subjected to mechanical forces such as ultrasonication, megasonication, impingement, and solution flow (laminar or turbulent). Such mechanical forces help in the removal of the polymeric material from the substrate. After the substrate has been contacted with the remover composition for a period of time sufficient to remove the polymer residue, the substrate is removed from contact with the remover composition. The substrate may then be optionally rinsed, such as with methanol, ethanol, isopropanol, acetone, DPM or similar solvent. Rinsing is required for conventional polymer removers as they typically contain one or more materials that are corrosive to thin metal layers. The present polymer remover compositions do not contain such corrosive materials, and thus, rinsing may not be necessary. If the substrate is optionally rinsed, it is then dried, such as by using a spin dry process or stream of inert gas such as nitrogen.

The compositions of the present invention are particularly useful for removing organic polymeric material in the manufacture of magnetoresistive sensors used in thin film head electronic devices. Magnetoresistive sensors can be prepared according to the present invention by disposing one or more polymeric materials on a magnetoresistive sensor substrate; and contacting the polymeric material on the magnetoresistive sensor substrate with a composition including one or more cyclic ketones for a period of time sufficient to remove the polymeric material. The magnetoresistive sensor substrate is then removed from contact with the composition, optionally rinsed, and dried.

The compositions of the present invention are substantially non-corrosive to substrates containing thin metal layers. The present remover compositions are effective at removing polymeric materials from MR materials faster and easier and with reduced corrosion of thin metal layers as compared to conventional stripping formulations.

A further advantage of the present invention is that the remover compositions can be recycled. For example, after polymeric material has been removed from a substrate, the spent stripping bath may optionally be filtered to remove any particulate residues, and then may be reformulated by addition of fresh materials to bring the composition back to the original specification. Alternatively, the spent stripping bath may optionally be filtered and then the solvents distilled. The distilled solvents may then be used to reformulate a desired remover composition or for any other purpose. Such process is effective in reducing waste generated during MR material manufacture.

The following examples are expected to illustrate various aspects of the present invention, but are not intended to limit the scope of the invention.

### EXAMPLE 1

A freshly electroplated wafer containing photoresist (used as a plating resist) disposed over thin metal layers is immersed in a stripper composition containing 100 wt % cyclopentanone (300 mL) for 10 minutes at 23° C. The sample is then ultrasonicated using a Branson 5210 Ultrasonic cleaner for an additional 20 minutes (which causes the temperature of the stripper composition to rise to approximately 42° C.). The substrate is then removed from the stripper bath and sprayed with isopropanol (“IPA”) using a squirt bottle to remove any cyclopentanone. The substrate is then further rinsed by immersing it in a beaker containing 2.5 L of IPA. This is followed by subsequently spraying with IPA from the squirt bottle again. The substrate is then dried under a stream of nitrogen gas prior to optical inspection. Optical inspection shows the wafer to be completely clean, all photoresist is removed and no stringers are present. The term “stringers” refers to residual polymeric material in the form of strands or strings.

### EXAMPLE 2

The process of Example 1 is repeated except that the wafer substrate used is allowed to sit for several days prior to cleaning. Such storage after electroplating typically makes removal of the polymeric material more difficult. The substrate is immersed in CP (300 mL) as above, but is then ultrasonicated for 30 minutes. The rinse is as above. Optical inspection shows that a clean substrate is obtained and no stringers are present.

### EXAMPLE 3

A freshly electroplated wafer containing thin metal layers and photoresist is immersed in one of the stripper compositions in Table 1 at room temperature and the bath is sonicated. After 30 min., the wafer is removed from the stripper composition and is then rinsed with IPA. Evaluation of the wafer by optical inspection is expected to show that the photoresist is completely removed and no stringers remain.

TABLE 1

| Sample | Composition |
|---|---|
| 3A | Cyclopentanone (16 wt %), DPM (84 wt %) |
| 3B | Cyclopentanone (36 wt %), DPM (64 wt %) |
| 3C | Cyclohexanone (42 wt %), 2-methyl-1,3- |
| | propanediol (20 wt %), DPM (38 wt %) |
| 3D | Cyclohexanone (35 wt %), 2-methyl-1,3- |
| | propanediol (25 wt %), ethylene glycol monobutyl |
| | ether (40 wt %) |
| 3E | Cyclopentanone (22 wt %), 2-methyl-1,3- |
| | propanediol (30 wt %), DPM (48 wt %) |

### EXAMPLE 4

Freshly electroplated wafers containing a photoresist disposed over thin metal layers are contacted with one of the removers listed in Table 2 below at the temperatures and for the times specified in Table 3. In each case, the remover composition is a static bath, i.e. no mechanical forces (such as sonication) are used. Following contact with the remover composition, the wafers are rinsed with IPA and evaluated by optical inspection. The results are also listed in the Table 3.

TABLE 2

| Remover Sample | Composition |
|---|---|
| Comparative A | N-Methyl pyrrolidone |
| Comparative B | DPM (24 wt %), DMSO (73 wt %), TMAH (2 wt %), |
| | benzotriazole (0.5 wt %) |
| Comparative C | Aminoethyl ethanolamine (20 wt %), DPM (80 wt %) |
| Comparative D | Cyclic ester (50 wt %), DMSO (50 wt %) |
| 4 | Cyclopentanone |

TABLE 3

| Remover Sample | Temperature (° C.) | Time (min.) | Results |
|---|---|---|---|
| Comparative A | 23 | 60 | Very small amount of resist removed, |
| | | | but cracked due to exposure to remover |
| Comparative B | 60 | 60 | Resist still present, but cracked due to |
| | | | exposure to remover |
| Comparative C | 80 | 30 | Resist removal starting but mostly still |
| | | | present, but cracked due to exposure to |
| | | | remover |
| Comparative D | 90 | 30 | Resist still present, but cracked due to |
| | | | exposure to remover |
| Invention 4* | 23 | 30 | Large areas of resist removed. |

*The wafer used for evaluation of sample 4 was an aged wafer following copper electroplating.

Comparative samples A-D are ineffective in removing the photoresist following copper electroplating. Sample 4 is evaluated on an aged electroplated wafer, which typically makes photoresist removal more difficult as compared to a freshly electroplated wafer. Sample 4 is effective at removing large amounts of photoresist at lower temperatures and at shorter contact times than conventional photoresist removers.

What is claimed is:

1. A method of removing polymeric material from a magnetoresistive substrate comprising the step of contacting the substrate containing polymeric material to be removed with a composition comprising one or more cyclic ketones.

2. The method of claim 1 wherein at least one cyclic ketone is selected from cyclopentanone or cyclohexanone.

3. The method of claim 1 wherein the composition further comprises one or more organic solvents.

4. The method of claim 1 wherein the composition further comprises one or more surfactants.

5. A method for preparing magnetoresistive sensors comprising the steps of disposing one or more polymeric materials on a magnetoresistive sensor substrate; and contacting the polymeric material on the magnetoresistive sensor substrate with a composition comprising one or more cyclic ketones for a period of time sufficient to remove the polymeric material.

6. The method of claim 5 wherein at least one polymeric material is selected from photoresist, antireflective coating, soldermask or combinations thereof.

7. The method of claim 5 wherein at least one cyclic ketone is selected from cyclopentanone or cyclohexanone.

8. The method of claim 5 wherein the composition further comprises one or more organic solvents.

9. The method of claim 5 wherein the composition further comprises one or more surfactants.

10. A composition suitable for the removal of polymeric material from a magnetoresistive substrate comprising cyclopentanone and one or more organic solvents selected from polyhydric alcohols or glycol ethers.
